(19) United States
(12) Patent Application Publication
(10) Pub. No.: US 2003/0176555 A1
(43) Pub. Date: Sep. 18, 2003

(54) Polypropylene-based resin composition and its injection molded article

(75) Inventors: Tsuyoshi Watanabe, Ichihara-shi (JP); Kenichi Okawa, Ichihara-shi (JP)

Correspondence Address: SUGHRUE MION, PLLC, 2100 Pennsylvania Avenue, NW, Washington, DC, 20037-3213, US

(73) Assignee: SUMITOMO CHEMICAL COMPANY, LIMITED

(21) Appl. No.: 10/334,715

(22) Filed: Jan. 2, 2003

(30) Foreign Application Priority Data
Jan. 8, 2002 (JP) 2002-001165

(51) Int. Cl. C08K 3/34

(52) U.S. Cl. 524/451; 524/515

(57) ABSTRACT

Disclosed are a polypropylene-based resin composition comprising 100 parts by weight of a resin comprising from 75 to 95% by weight of a propylene-ethylene block copolymer (A-1) and from 5 to 25% by weight of a copolymer rubber of ethylene and α-olefin having from 4 to 20 carbon atoms (B) and from 0.3 to 2 parts by weight of talc (C), and a polypropylene-based resin composition comprising 100 parts by weight of a resin comprising from 55 to 94% by weight of a propylene-ethylene block copolymer (A-1), from 1 to 20% by weight of a propylene homopolymer (A-2) and from 5 to 25% by weight of a copolymer rubber of ethylene and α-olefin having from 4 to 20 carbon atoms (B) and from 0.3 to 2 parts by weight of talc (C).

### BACKGROUND OF THE INVENTION

1. Field to the Invention

The present invention relates to a polypropylene-based resin composition and to its injection molded article, and more particularly, to a polypropylene-based resin composition excellent in elongation, which is a factor of formability, rigidity and impact resistance, particularly of impact resistance, and to its injection molded article.

2. Description of the Related Art

In recent years, materials that are of light weight, of good formability and of excellent rigidity and impact resistance have been demanded as materials for automobiles or those for home electric appliances and polypropylene resins are usually used. Conventionally, a method comprising addition of an inorganic filler is known as a method for improving rigidity. A method comprising addition of a rubber component is known as a method for improving impact resistance. In addition, a method comprising employment of a large MFR is known as a method for improving formability.

For example, JP,60-58459,A discloses a polypropylene resin composition that has a high rigidity and a high molding flowability, that is excellent in paintability and particularly in bass impact, and that is inexpensive, the resin composition comprising 100 parts by weight in total of a crystalline ethylene-propylene block copolymer and an ethylene-propylene copolymer rubber and from 2 to 25 parts by weight of an inorganic filler.

In addition, JP,7-33919,A discloses a talc-containing polypropylene resin composition wherein from 0.5 to 20 parts by weight of talc is incorporated in 100 parts by weight of resin components containing from 50 to 98% by weight of a highly crystalline polypropylene homopolymer, from 40 to 1% by weight of an ethylene-propylene block copolymer and from 18 to 2% by weight of an elastomer.

However, the polypropylene resin composition disclosed in JP,60-58459,A mentioned above is insufficient in elongation, which is a factor of formability, rigidity and impact resistance, particularly of impact resistance, due to the use of the ethylene-propylene copolymer rubber and are awaited for improvement in those physical properties. Moreover, the polypropylene resin composition disclosed in JP,7-33919,A mentioned above has an insufficient impact resistance because of the use of from 50 to 98% by weight of the highly crystalline polypropylene homopolymer and is awaited for further improvement.

### SUMMARY OF THE INVENTION

The object of the present invention is to provide a polypropylene-based resin composition excellent in elongation, which is a factor of formability, rigidity and impact resistance, particularly of impact resistance, and to its injection molded article.

In view of such actual situations, the present inventors have been found, through their diligent investigations, that the above problem can be solved by a polypropylene-based resin composition containing talc the content of which is within a certain range based on a certain content of a resin containing a propylene-ethylene block copolymer the weight ratio of which is within a certain range and a copolymer rubber of ethylene and an α-olefin having from 4 to 20 carbon atoms, the weight ratio of which is within a certain range, by a polypropylene-based resin composition containing talc the content of which is within a certain range based on a certain content of a resin containing a propylene-ethylene block copolymer the weight ratio of which is within a certain range, a propylene homopolymer the content of which is within a certain range and a copolymer rubber of ethylene and an α-olefin having from 4 to 20 carbon atoms, the weight ratio of which is within a certain range, and by injection molded articles obtained by injection molding the aforementioned polypropylene-based resin compositions.

Namely, a first aspect of the present invention is a polypropylene-based resin composition comprising

100 parts by weight of a resin comprising from 75 to 95% by weight of a propylene-ethylene block copolymer (A-1) and from 5 to 25% by weight of a copolymer rubber of ethylene and α-olefin having from 4 to 20 carbon atoms (B), provided that the sum of the amounts of the propylene-ethylene block copolymer (A-1) and the copolymer rubber (B) is 100% by weight, and

from 0.3 to 2 parts by weight of talc (C).

A second embodiment of the present invention is a polypropylene-based resin composition comprising

100 parts by weight of a resin comprising from 55 to 94% by weight of a propylene-ethylene block copolymer (A-1), from 1 to 20% by weight of a propylene homopolymer (A-2) and from 5 to 25% by weight of a copolymer rubber of ethylene and α-olefin having from 4 to 20 carbon atoms (B), provided that the sum of the amounts of the propylene-ethylene block copolymer (A-1), the propylene homopolymer (A-2) and the copolymer rubber (B) is 100% by weight, and

from 0.3 to 2 parts by weight of talc (C).

The present invention is also directed to a molded article obtained by injection molding one of the above polypropylene-based resin compositions.

### DETAILED DESCRIPTION OF PREFERRED EMBODIMENTS

The propylene-ethylene copolymer (A-1) used in the present invention is a copolymer having a propylene homopolymer portion as a first segment and a propylene-ethylene random copolymer portion as a second segment.

The propylene homopolymer portion and the propylene-ethylene random copolymer portion, which are the first segment and the second segment, respectively, of the propylene-ethylene block copolymer (A-1) used in the present invention, have weight ratios of from 95 to 60% by weight for the first segment and from 5 to 40% by weight for the second segment, preferably from 90 to 65% by weight for the first segment and from 10 to 35% by weight for the second segment, provided that the total weight of the propylene-ethylene block copolymer (A-1) is let be 100% by weight.

The Q value (Mw/Mn), which is the ratio of the weight average molecular weight (Mw) to the number average molecular weight (Mn) and which indicates the molecular weight distribution of the first segment (propylene homopolymer portion) in the copolymer (A-1) is usually from 3 to 5, preferably from 3.5 to 4.5, from the viewpoints of flowability or balance between rigidity and impact resistance.

The isotactic pentad fraction of the first segment in the copolymer (A-1) is usually not less than 0.97, more preferably not less than 0.98 from the viewpoints of rigidity and heat resistance.

The ethylene content (C2′) EP of the second segment in the copolymer (A-1) is usually from 25 to 55% by weight, more preferably from 30 to 50% by weight from the viewpoint of impact resistance, provided that the total weight of the second segment is let be 100% by weight.

The intrinsic viscosity [η]EP of the second segment is usually from 1 to 6 dl/g, more preferably from 2 to 5.5 dl/g from the viewpoints of balance between rigidity and impact resistance, generation of pimples, and surface quality.

The MFR of the copolymer (A-1) at 230° C. is usually not less than 25 g/10 min, preferably not less than 30 g/10 min from the viewpoint of formability.

The method for producing the copolymer (A-1) is not particularly restricted and includes a method in which the propylene homopolymer portion, which is the first segment, is produced in a first step and the propylene-ethylene random copolymer portion, which is the second segment, is produced in a second step.

In addition, can be mentioned a method in which the copolymer is produced by a known polymerization method using a known polymerization catalyst. The known polymerization catalyst includes Ziegler catalysts and metallocene catalysts. The known polymerization method includes e.g. slurry polymerization and gas phase polymerization.

As the propylene homopolymer (A-2) used in the present invention, can be employed propylene homopolymers the same as those mentioned as the propylene homopolymer which is the first segment of the propylene-ethylene block copolymer (A-1) used in the present invention.

The α-olefins having from 4 to 20 carbon atoms used in the copolymer rubber of ethylene and a-olefin having from 4 to 20 carbon atoms (B) used in the present invention are exemplified by 1-butene, isobutene, 1-pentene, 2-methyl-1-butene, 3-methyl-1-butene, 1-hexene, 2-methyl-1-pentene, 3-methyl-1-pentene, 4-methyl-1-pentene, 1-octene, 1-nonene, 1-decene, 1-undecene, 1-dodecene, etc. Preferred are 1-hexene and 1-octene. In addition, the α-olefins described above may be used alone or in combination of two or more of them.

The MFR of the copolymer rubber (B) at 190° C. is usually from 0.3 to 30 g/10 min and preferably from 0.5 to 20 g/10 min from the viewpoint of impact strength or dispersibility to the propylene-ethylene block copolymer.

Moreover, the specific gravity of the copolymer rubber (B) is usually less than 0.90 g/cm³ and more preferably not more than 0.89 g/cm³ from the viewpoint of impact strength or dispersibility to the propylene-ethylene block copolymer.

The method for producing the copolymer rubber (B) is not particularly restricted and can be mentioned a method in which the copolymer is produced by a known polymerization method using a known polymerization catalyst. The known polymerization catalyst is exemplified by Ziegler-Natta catalyst systems made up, for example, of a vanadium compound, an organoaluminum compound and a halogenated ester compound, catalyst systems comprising a combination of an alumoxane or a boron compound and a metallocene compound in which a group with at least one cyclopentadienyl anion backbone is coordinated to a titanium atom, a zirconium atom or a hafnium atom, which are so-called metallocene catalyst systems.

The known polymerization method is exemplified by a method in which ethylene and an α-olefin are copolymerized in an inert organic solvent such as a hydrocarbon compound.

The talc (C) used in the present invention is not particularly restricted, but, from the viewpoints of impact strength, luster or good appearance of molded articles, the average particular diameter of talc (C) is usually not more than 10 μm, preferably not more than 5 μm. The average particle diameter of talc means a 50% particle diameter D₅₀ determined from an integrated distribution curve of the undersize method obtained by subjecting a suspension of the particle in a dispersion medium such as water, alcohol, or the like to measurement using a centrifugal settling type particle size distribution measuring device.

The talc (C) may be employed as received without any treatment. Alternatively, it may be employed after treatment of its surface using a variety of known silane couplers, titanium couplers, or surfactants in order to improve the interfacial adhesiveness to the polypropylene-based resin and to improve the dispersibility to the polypropylene-based resin. The surfactant is exemplified by higher fatty acids, higher fatty acid esters, higher fatty acid amides and higher fatty acid salts.

In a first embodiment of the present invention, the polypropylene-based resin composition comprises

100 parts by weight of a resin comprising a propylene-ethylene copolymer (A-1) and a copolymer rubber of ethylene and α-olefin having from 4 to 20 carbon atoms (B), wherein the propylene-ethylene block copolymer (A-1) accounts for from 75 to 95% by weight of the sum of (A-1) and (B) and the copolymer rubber (B) accounts for from 5 to 25% by weight of the sum of (A-1) and (B), provided that the amounts of (A-1) and (B) sum into 100% by weight, and

from 0.3 to 2 parts by weight of talc (C).

In the resin to which talc is incorporated, if the amount of the propylene-ethylene block copolymer (A-1) is less than 75% by weight, the rigidity of the resin composition will be insufficient, whereas if it is more than 95% by weight, the impact resistance will be insufficient. If the amount of the copolymer rubber (B) is less than 5% by weight, the impact resistance of the resin composition will be insufficient, whereas if it is more than 25% by weight, the resin composition will have an insufficient rigidity. With respect to talc (C), not only when the amount thereof is less than 0.3 part by weight but also when the amount thereof is more than 2 parts by weight, only an insufficient effect of improving the impact resistance is achieved. The amount of the propylene-ethylene block copolymer (A-1) and that of the copolymer rubber (B) are preferably from 80 to 92% by weight and from 8 to 20% by weight, respectively. The amount of talc (C) is preferably from 0.5 to 1.5 parts by weight based on 100 parts by weight of the resin.

On the other hand, in a second embodiment of the present invention, the polypropylene-based resin composition comprises

100 parts by weight of a resin comprising a propylene-ethylene block copolymer (A-1), a propylene homopolymer (A-2) and a copolymer rubber of ethylene and α-olefin having from 4 to 20 carbon atoms (B), wherein the propylene-ethylene block copolymer (A-1) accounts for from 55 to 94% by weight of the sum of (A-1), (A-2) and (B), the propylene homopolymer accounts for from 1 to 20% by weight of the sum of (A-1), (A-2) and (B), and the copolymer rubber (B) accounts for from 5 to 25% by weight of the sum of (A-1), (A-2) and (B), provided that the amounts of (A-1), (A-2) and (B) sum into 100% by weight, and

from 0.3 to 2 parts by weight of talc (C).

In the resin to which talc is incorporated, if the amount of the propylene-ethylene block copolymer (A-1) is less than 55% by weight, the rigidity of the resin composition will be insufficient, whereas if it is more than 94% by weight, the impact resistance will be insufficient. If the amount of the propylene homopolymer (A-2) is more than 20% by weight, the impact resistance of the resin composition will be insufficient. If the amount of the copolymer rubber (B) is less than 5% by weight, the impact resistance of the resin composition will be insufficient, whereas if it is more than 25% by weight, the resin composition will have an insufficient rigidity. With respect to talc (C), not only when the amount thereof is less than 0.3 part by weight but also when the amount thereof is more than 2 parts by weight, only an insufficient effect of improving the impact resistance is achieved. The amount of the propylene-ethylene block copolymer (A-1), that of the propylene homopolymer (A-2) and that of the copolymer rubber (B) are preferably from 70 to 87% by weight, from 5 to 10% by weight and from 8 to 20% by weight, respectively. The amount of talc (C) is preferably from 0.5 to 1.5 parts by weight based on 100 parts by weight of the resin.

The method for producing the polypropylene-based resin composition of the present invention may be a method in which the individual ingredients are mixed and kneaded. The apparatus used for the kneading includes a single screw extruder, a twin screw extruder, a Banbury mixer, a hot roll, and the like. The kneading temperature is usually from 170 to 250° C. and the kneading time is usually from 1 to 20 minutes. The mixing of individual ingredients may be carried out either simultaneously or separately.

The method for separate mixing is not particularly restricted and include, for example, the following methods (1) through (5):

(1) A method which comprises kneading a propylene-ethylene block copolymer (A-1) and talc (C) and then adding a copolymer rubber of ethylene and α-olefin having from 4 to 20 carbon atoms (B).

(2) A method which comprises kneading talc (C) previously in a high concentration with a propylene-ethylene block copolymer (A-1) to form a master batch, and then kneading the master batch while diluting with a propylene-ethylene block copolymer (A-1) or a copolymer rubber of ethylene and a-olefin having from 4 to 20 carbon atoms (B).

(3) A method which comprises kneading a propylene-ethylene block copolymer (A-1) and a copolymer rubber of ethylene and α-olefin having from 4 to 20 carbon atoms (B), and then adding talc (C) and kneading.

(4) A method which comprises kneading a copolymer rubber of ethylene and α-olefin having from 4 to 20 carbon atoms (B) previously in a high concentration with a propylene-ethylene block copolymer (A-1) to form a master batch, and adding to it a propylene-ethylene block copolymer (A-1) and talc (C) and kneading.

(5) A method which comprises kneading previously a propylene-ethylene block copolymer (A-1) and talc (C) and, separately, a propylene-ethylene block copolymer (A-1) and a copolymer rubber of ethylene and α-olefin having from 4 to 20 carbon atoms (B), and thereafter combining them and kneading.

In the methods (1) through (5), a propylene homopolymer (A-2) may optionally be mixed.

To the polypropylene-based resin composition of the present invention may be incorporated, as required, additives such as an antioxidant, an ultraviolet absorber, a lubricant, a pigment, an anti-static agent, a cupper inhibitor, a flame retardant, a neutralizing agent, a foaming agent, a plasticizer, a nucleating agent, an anti-foaming agent and a crosslinking agent.

The injection-molded article of the present invention is one obtained by a known injection molding of the polypropylene resin composition of the present invention. The injection-molded article of the present invention is suitably employed especially as a molded article for automobiles and electric home appliances.

### EXAMPLES

The present invention is illustrated by the following examples and comparative examples. The present invention, however, is not restricted to the examples.

The methods for measuring physical properties used in Examples and Comparative Examples are shown below.

(1) Melt Flow Rate (MFR, Unit: g/10 min)

Measurement was carried out according to the method provided in JIS K 6758. The measurement was carried out at a temperature of 230° C. and a load of 2.16 kg, unless otherwise stated.

(2) Flexural Modulus (Unit: MPa)

Measurement was carried out according to the method provided in JIS K 7203. Specimens molded by injection molding were used. Each specimen had a thickness of 3.2 mm and was evaluated for flexural modulus under conditions including a span length of 60 mm and a load speed of 5.0 mm/min. The measurement was carried out at a temperature of 23° C.

(3) Izod Impact Strength (Unit: KJ/m²)

Measurement was carried out according to the method provided in JIS K 7110. Specimens molded by injection molding were used. Each specimen had a thickness of 6.4 mm. Specimens with a notch resulting from notching after molding were evaluated for impact strength. The measurement was carried out at a temperature of 23° C.

(4) Elongation at Break (UE, Unit: %)

Measurement was carried out according to the method provided in ASTM D638. Specimens molded by injection molding were used. Each specimen had a thickness of 3.2 mm. Elongation at break (UE) was evaluated at a tensile speed of 50 mm/min. The measurement was carried out at a temperature of 23° C.

(5) Ethylene Content (Unit: % by Weight)

The ethylene content was determined by a working curve method using the absorbance of characteristic absorptions of a methyl group (—CH₃) and a methylene group (—CH₂—) obtained by preparing a press sheet and measuring its infrared absorption spectrum.

(6) Intrinsic Viscosity ([η], Unit: dl/g)

Reduced viscosities were measured at three points of concentrations of 0.1, 0.2 and 0.5 g/dl using an Ubbellohde type viscometer. Intrinsic viscosity was calculated by a calculation method described on page 491 in “Kobunshi Yoeki (Polymer Solution), Kobunshi Jikkengaku (Polymer Experiment Study) 11” (published by Kyoritsu Shuppan K.K., 1982), namely, by an extrapolation method in which reduced viscosities are plotted against concentrations and the concentration is extrapolated in zero.

Regarding polypropylene, the intrinsic viscosity was measured at a temperature of 135° C. using tetralin as a solvent.

(7) Molecular Weight Distribution (Q Value)

Measurement was carried out by gel permeation chromatography (GPC) under the following conditions.

GPC: Model 150C manufactured by Waters

Column: Shodex 80 MA manufactured by Showa Denko, two columns

Amount of sample: 300 μl (Polymer concentration 0.2 wt %)

Flow rate: 1 ml/min

Temperature: 135° C.

Solvent: o-Dichlorobenzene

Using a standard polystyrene manufactured by Tosoh Corp., a working curve of eluted volume vs. molecular weight was made. Using the working curve, the weight average molecular weight and the number average molecular weight, in terms of polystyrene, of the sample tested were determined and then a Q value=weight average molecular weight/number average molecular weight was calculated as an index of molecular weight distribution.

(8) Isotactic Pentad Fraction (Unit: %)

The isotactic pentad fraction was measured by a method reported and disclosed in A. Zambelli et al., Macromolecules, 6, 925 (1973). Namely, determined was a fraction of isotactic chains in the form of pentad unit in a polypropylene molecule chain, in other words, a fraction of propylene monomer units existing in the center of a chain in which five propylene monomer units are meso-bonded measured by use of ¹³C-NMR. However, the assignment of NMR absorption peaks was conducted based on Macromolecules, 8, 687 (1975) published thereafter.

Specifically, the isotactic pentad fraction was measured as an area fraction of mmmm peaks in all the absorption peaks in the methyl carbon region of a ¹³C-NMR spectrum. According to this method, the isotactic pentad fraction of an NPL standard substance, CRM No. M19-14 Polypropylene PP/MWD/2 available from NATIONAL PHYSICAL LABORATORY, G.B. was measured to be 0.944.

(9) Weight Ratio of Propylene-Ethylene Random Copolymer Portion to the Whole Block Copolymer in Propylene-Ethylene Block Copolymer (X, % by Weight)

In a propylene-ethylene block copolymer, the weight ratio, X (% by weight), of a propylene-ethylene random copolymer portion to the whole block copolymer is determined according to the following equation after the measurement of the amounts of heat of crystal fusion of the propylene homopolymer portion and the whole block copolymer.

X=1−(ΔHf)T/(ΔHf)P

(ΔHf)T=Amount of heat of fusion of the whole block copolymer (cal/g)

(ΔHf)P=Amount of heat of fusion of propylene homopolymer portion (cal/g)

(10) Ethylene Content of Propylene-Ethylene Random Copolymer Portion (Unit: % by Weight)

The ethylene content of a propylene-ethylene random copolymer portion was determined by calculation according to the following equation after the measurement of the ethylene content (% by weight) of the whole block copolymer by an infrared absorption spectrum method.

(C2′)EP=(C2′)T/X

(C2′)T=Ethylene content of the whole block copolymer (% by weight)

(C2′)EP=Ethylene content of propylene-ethylene random copolymer portion (% by weight)

(11) Intrinsic Viscosity of Propylene-Ethylene Random Copolymer Portion ([η]EP, Unit: dl/g)

The intrinsic viscosity, [η]EP, of the propylene-ethylene random copolymer portion in a propylene-ethylene block copolymer is determined by calculation according to the following equation after the measurement of intrinsic viscosities of a propylene homopolymer portion and the whole block copolymer.

[η]EP=[η]T/X=(1/X−1)[η]P

[η]P: Intrinsic viscosity of propylene homopolymer portion (dl/g)

[η]T: Intrinsic viscosity of the whole block copolymer (dl/g)

The intrinsic viscosity, [η]P, of the propylene homopolymer portion, which is the first segment of the propylene-ethylene block copolymer, was determined using a propylene homopolymer separated from a polymerization tank after the production of the propylene homopolymer portion, which is a first step, during the production of the propylene-ethylene block copolymer.

Next, the samples used in Examples and Comparative Examples are shown below.

(Sample)

(A-1) Propylene-ethylene block copolymer (BC-1)

As a propylene-ethylene block copolymer (BC-1) was used WPX5343 manufactured by Sumitomo Chemical Co., Ltd.

The propylene homopolymer portion (first segment) had a molecular weight distribution (Q value) of 4.0, an intrinsic viscosity ([η]P) of 0.93 dl/g, and an isotactic pentad fraction of 0.97. The propylene-ethylene random copolymer portion (second segment) had an intrinsic viscosity ([η]EP) of 5.0 dl/g, a weight ratio to the propylene-ethylene block copolymer (BC-1) of 13.0% by weight, and an ethylene content of 32.0% by weight.

(A-2) Propylene homopolymer (PP-1)

As the propylene homopolymer (PP-1) was used a propylene homopolymer having a molecular weight distribution (Q value) of 4.1, an intrinsic viscosity ([η]P) of 0.77 dl/g, and an isotactic pentad fraction of 0.99.

(B) Copolymer rubber (EOR-1)

Engage 8200 (Ethylene-1-octene copolymer rubber) manufactured by DuPont Dow Elastomers L.L.C.

EOR-1 had a density of 0.87 g/cm³ and an MFR (190° C.) of 5 g/10 min.

(C) Talc (Talc-1)

MWHS-T manufactured by Hayashi Kasei Co., Ltd.

Talc-1 had an average particle diameter of 2.7 μm. Examples 1, 2 and Comparative Examples 1 to 3

(Polypropylene-Based Resin Compositions)

Polypropylene-based resin compositions were prepared in the following method. A propylene-ethylene block copolymer (BC-1), a propylene homopolymer (PP-1), an ethylene-1-octene copolymer rubber (EOR-1) and talc (Tal-1) were pre-mixed in a composition given in TABLE 1 uniformly with a Henschel mixer and a tumbler and then a polypropylene-based resin composition was produced with a twin screw extruder (Model TEX44SS-31.5BW-2V manufactured by Japan Steel Works, Ltd.) at an extrusion rate of 50 kg/hr and a screw rotation speed of 900 rpm under bent suction. The MFR of the resulting polypropylene-based resin composition was measured. The results are shown in TABLE 2.

(Injection Molded Article)

Specimens for evaluation of physical properties were prepared under the following injection molding conditions. Following to drying in a hot air dryer at 120° C. for 2 hours, the polypropylene-based resin composition obtained above was subjected to injection molding using an injection molding machine Model IS150E-V manufactured by TOSHIBA MACHINE Co., Ltd. at a molding temperature of 220° C., a mold cooling temperature of 50° C., a injection time of 15 sec and a cooling time of 30 sec. Each of the injection molded articles obtained was measured for flexural modulus, Izod impact strength, and elongation at break. The results are shown in TABLE 2.

TABLE 1

| | Composition (% by weight) | | | |
|---|---|---|---|---|
| | BC-1 | PP-1 | EOR-1 | Talc-1 |
| Example 1 | 72 | 8 | 20 | 0.5 |
| Example 2 | 72 | 8 | 20 | 1 |
| Comparative Example 1 | 72 | 8 | 20 | — |
| Comparative Example 2 | 72 | 8 | 20 | 3 |
| Comparative Example 3 | 72 | 8 | 20 | 5 |

TABLE 2

| | Melt Flow | Flexural | Izod impact | |
|---|---|---|---|---|
| | Rate | Modulus | strength | Elongation |
| | (g/10 mm) | (MPa) | (KJ/m²) | at Break (%) |
| Example 1 | 38 | 1180 | 15.8 | 410 |
| Example 2 | 38 | 1220 | 23.7 | 490 |
| Comparative | 39 | 1040 | 15.6 | 150 |
| Example 1 | | | | |
| Comparative | 39 | 1260 | 29.9 | 290 |
| Example 2 | | | | |
| Comparative | 39 | 1460 | 27.7 | 160 |
| Example | | | | |

It is clear that Examples 1 and 2, which satisfy the requirements of the present invention, are excellent in formability (melt flow rate), rigidity (flexural modulus) and impact resistance (Izod impact strength), in particular, in elongation (elongation at break), which is one of the factors of impact strength.

In contrast to this, it is clear that Comparative Examples 1 to 3, which do not satisfy the amount of talc incorporated which is one of the requirements of the present invention, are insufficient in balance between rigidity (flexural modulus) and elongation (elongation at break), which is one of the factors of impact resistance.

As described in detail above, the present invention can afford a polypropylene-based resin composition excellent in elongation, which is a factor of formability, rigidity and impact resistance, particularly of impact resistance, and to its injection molded article.

What is claimed is:

1. A polypropylene-based resin composition comprising 100 parts by weight of a resin comprising from 75 to 95% by weight of a propylene-ethylene block copolymer (A-1) and from 5 to 25% by weight of a copolymer rubber of ethylene and α-olefin having from 4 to 20 carbon atoms (B), provided that the sum of the amounts of the propylene-ethylene block copolymer (A-1) and the copolymer rubber (B) is 100% by weight, and
from 0.3 to 2 parts by weight of talc (C).

2. A polypropylene-based resin composition comprising 100 parts by weight of a resin comprising from 55 to 94% by weight of a propylene-ethylene block copolymer (A-1), from 1 to 20% by weight of a propylene homopolymer (A-2) and from 5 to 25% by weight of a copolymer rubber of ethylene and α-olefin having from 4 to 20 carbon atoms (B), provided that the sum of the amounts of the propylene-ethylene block copolymer (A-1), the propylene homopolymer (A-2) and the copolymer rubber (B) is 100% by weight, and
from 0.3 to 2 parts by weight of talc (C).

3. The polypropylene resin composition according to claim 1 or 2, wherein the content of (C) talc is from 0.5 to 1.5 parts by weight.

4. The polypropylene resin composition according to claim 1 or 2, wherein in the copolymer rubber of ethylene and α-olefin having from 4 to 20 carbon atoms (B), the α-olefin is 1-hexene or 1-octene, the copolymer rubber (B) has a density of 0.89 g/cm³ or less, and the copolymer rubber (B) has an MFR of from 0.5 to 20 g/10 min at 190° C.

5. The polypropylene resin composition according to claim 1 or 2, wherein the polypropylene-based resin composition has an MFR of from 30 to 50 g/10 min.

6. An injection molded article characterized by being obtained by injection molding the polypropylene resin composition according to any one of claims 1 to 5.
